(19) United States
(12) Patent Application Publication
(10) Pub. No.: US 2007/0281091 A1
(43) Pub. Date: Dec. 6, 2007

(54) Polyimide insulative layers in multi-layered printed electronic features

(75) Inventors: Mark H. Kowalski, Albuquerque, NM (US); Chuck Edwards, Rio Rancho, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/443,305

(22) Filed: May 31, 2006

(51) Int. Cl. B05D 3/02; B05D 5/12; B05D 5/00

(52) U.S. Cl. 427/256; 427/384; 427/58

(57) ABSTRACT

Processes for forming polyimide coatings during the formation of printed electronic features. In various embodiments, the processes include the steps of: (a) applying a polyimide precursor ink comprising a polyimide precursor onto a substrate or to an electronic feature disposed thereon, preferably through a direct write printing process, e.g., ink-jet printing, (b) converting the polyimide precursor to a polyimide coating; and (c) optionally forming an electronic feature on the polyimide coating.

### FIELD OF THE INVENTION

The present invention relates to printing electronic features. More specifically, the invention relates to surface modification and encapsulation with polyimide layers that may be used during the formation of printable electronic features.

### BACKGROUND OF THE INVENTION

The electronics, display and energy industries rely on the formation of coatings and patterns of conductive materials on substrates to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

One problem associated with the formation of printable electronic features is substrate variability. Although most substrates typically provide, at a macroscopic level, a substantially planar surface for receiving a printable electronic feature, such substrates often exhibit highly irregular surfaces on a microscopic level. These surface irregularities may result in variability of the electronic properties of the printable electronic features ultimately formed thereon. Accordingly, it may be difficult to repeatably form a printable electronic feature having desired electronic properties on an irregular substrate surface.

Thus, the need exists for processes for mitigating surface irregularities on a substrate surface and for providing the ability to repeatably manufacture printable electronic features having desired electronic properties regardless of such surface irregularities.

Another problem associated with electronic features formed by direct write (e.g., ink-jet) printing techniques is that they may exhibit circuit instability and variation due to atmospheric exposure. Conventionally, printable electronic features have been exposed to atmospheric air and moisture, e.g., as water vapor. Over time, the oxygen from air may oxidize the metallic components contained in the electronic feature causing a change in electrical properties. Similarly, water in the air may slowly react with the components in the electronic features, particularly resistive compositions contained in certain electronic features, to cause an undesired change in electrical properties.

Thus, the need also exists for more stable printable electronic features that are less susceptible to electronic variability caused by atmospheric exposure. The need also exists for processes for making such printable electronic features.

Another problem associated with electronic features is substrate composition variability. Electronic features may be formed on a variety of different substrate compositions—for example, on plastic substrates, on paper-based substrates or on metal substrates, to name a few. Each of these substrates possesses a different physical property, e.g., conductivity and heat stability, that may impact the performance of an electronic feature formed thereon. As a result, electronic features may undesirably exhibit performance variability depending on the type of substrates on which they is formed.

Accordingly, the need also exists for a means to eliminate or minimize electronic feature variability that is created by variances in substrate surface compositions and properties.

### SUMMARY OF THE INVENTION

In one aspect, the invention relates to a process for forming an electronic feature on a polyimide surface, the process comprising the steps of: (a) providing a substrate having a first surface; (b) depositing a polyimide precursor ink comprising a polyimide precursor on at least a portion of the first surface; (c) converting the polyimide precursor to a polyimide on the first surface; and (d) forming an electronic feature on the polyimide. Optionally, the converting step forms a coating comprising the polyimide on the first surface. The coating optionally has a coating surface that is more planar than the first surface.

Preferably, the polyimide precursor comprises a polyamic acid or ester, e.g., a polyamic acid or ester of the formula:

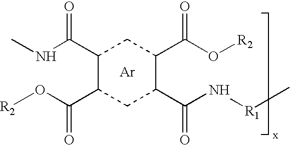

wherein

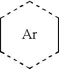

is an aromatic group optionally selected from the group consisting of phenyl, biphenyl and naphthalenyl; R₁ is selected from the group consisting of an alkyl group, an alkenyl group, an alkynyl group and an aromatic group; and R₂ is selected from the group consisting of H, an alkyl group, an alkenyl group, and an alkynyl group. For example, R₁ optionally is an alkyl group selected from the group consisting of ethyl, methyl and propyl. Alternatively, R₁ is an aromatic group selected from the group consisting of phenyl, biphenyl and naphthalenyl. Preferably, R₂ is H. Alternatively, R₂ is an alkyl group selected from the group consisting of methyl, ethyl and propyl.

the polyimide precursor ink optionally further comprises N-methyl pyrrolidone, dimethyl acetamide, dimethyl formamide, ethylene glycol mono-n-butyl ether, diethylene glycol methyl ethyl ether, γ-butyrolactone, dimethyl sulfoxide, diethyleneglycol butylether, or ethanolamine.

The converting step optionally comprises heating the deposited polyimide precursor ink. The heating optionally comprises heating the deposited polyimide precursor ink to a maximum temperature of from about 150° C. to about 350° C.

The depositing step optionally comprises depositing the polyimide precursor ink onto the first surface by a direct write printing process. Preferably, the depositing step comprises depositing the polyimide precursor ink onto the first surface by an ink jet printing process.

The polyimide preferably has the formula:

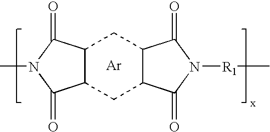

wherein

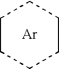

is an aromatic group optionally selected from the group consisting of phenyl, biphenyl and naphthalenyl; and wherein R₁ is selected from the group consisting of an alkyl group, an alkenyl group, an alkynyl group and an aromatic group. R₁ optionally is an alkyl group selected from the group consisting of ethyl, methyl and propyl. In another embodiment, R₁ is an aromatic group selected from the group consisting of phenyl, biphenyl and naphthalenyl.

The polyimide precursor ink preferably has a viscosity of less than about 50 centipoise and optionally a surface tension of from about 10 dynes/cm to about 50 dynes/cm.

The forming optionally comprises: applying a second ink onto at least a portion of the polyimide; and treating the second ink under conditions effective to form at least a portion of the electronic feature. The treating of the second ink optionally comprises heating the deposited second ink to a maximum temperature of from about 150° C. to about 400° C.

The substrate optionally is selected from the group consisting of a fluorinated polymer, polyimide, epoxy resin, polycarbonate, polyester, polyethylene, polypropylene, polyvinyl chloride, ABS copolymer, wood, paper, metallic foil, glass, flexible fiberboard, non-woven polymeric fabric, and cloth. In a preferred embodiment, the substrate comprises a polyimide film. Optionally, the substrate comprises glass.

The electronic feature optionally is selected from the group consisting of a conductor, a resistor, a capacitor, an inductor, a dielectric and a semiconductor.

The polyimide optionally has a molecular weight ranging from about 10,000 to about 10,000,000 amu.

In another aspect, the invention relates to a process for forming a multi-layer feature, the process comprising the steps of: (a) providing at least a portion of a first electronic feature on a substrate, the first electronic feature having a feature surface; (b) depositing a polyimide precursor ink comprising a polyimide precursor on at least a portion of the feature surface; (c) converting the polyimide precursor to a polyimide on the at least a portion of the feature surface.

Optionally, the process further comprises the step of: (d) depositing a second ink on at least a portion of the polyimide. Optionally, the process further comprises the step of: (e) treating the second ink under conditions effective to form at least a portion of a second electronic feature. The second ink optionally comprises a metallic composition. The metallic composition comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead. In another embodiment, the metallic composition comprises an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead. The second ink optionally comprises a metal precursor to a metal, the metal being selected from the group consisting of silver, gold, copper, nickel, cobalt, palladium, platinum, indium, tin, zinc, titanium, chromium, tantalum, tungsten, iron, rhodium, iridium, ruthenium, osmium and lead.

In one embodiment, the first electronic feature comprises a first conductive trace and the second electronic feature comprises a second conductive trace, and the first and second conductive traces are insulated from one another by the polyimide.

In one embodiment, the polyimide precursor ink is selectively deposited on a portion of the feature surface to form a polyimide layer comprising the polyimide, the polyimide layer having a void therein, the process further comprising the steps of: (d) depositing a via ink in at least a portion of the void; and (e) treating the deposited via ink under conditions effective to form a via. In this embodiment, the process optionally comprises the step of: (f) depositing a second ink on at least a portion of the polyimide layer. Optionally, the process further comprises the step of: (g) treating the second ink under conditions effective to form at least a portion of a second electronic feature, the second electronic feature being electrically coupled to the first electronic feature by the via. Steps (e) and (g) optionally occur simultaneously. The treating of the second ink optionally comprises heating the deposited second ink to a maximum temperature of from about 150° C. to about 400° C.

### BRIEF DESCRIPTION OF THE DRAWINGS

The present invention will be better understood in view of the following non-limiting figures, wherein:

FIG. 1 illustrates a first substrate having a first type of surface irregularity;

FIG. 2 illustrates a second substrate having a second type of surface irregularity;

FIG. 3 illustrates a polyimide planarizing feature planarizing the first substrate according to one embodiment of the present invention;

FIG. 4 illustrates a polyimide planarizing feature planarizing the second substrate according to another embodiment of the present invention;

FIG. 5 illustrates a polyimide-encapsulated electronic feature according to another embodiment of the present invention;

FIG. 6 illustrates a void formed during an encapsulation process;

FIG. 7 illustrates the formation of a via in the void according to another embodiment of the present invention; and

FIG. 8 illustrates the formation of a secondary electronic feature connected to a first electronic feature by the via.

### DETAILED DESCRIPTION OF THE INVENTION

### I. Introduction

In one aspect, the present invention is directed to processes for modifying a substrate surface with a polyimide coating or layer. The coating optionally planarizes the substrate surface prior to application of an electronic ink to form a printed electronic feature. As used herein, the term “planarize” and variations thereof means to modify a substrate surface to make it more planar (e.g., on a microscopic and/or on a macroscopic scale). In another embodiment, the coating does not planarize the substrate surface because it does not make the substrate surface more planar, but modifies the substrate surface by providing a polyimide surface having predictable surface properties, on which an electronic feature may be formed. In another aspect, the polyimide coating encapsulates a first electronic feature, for example, to protect the first electronic feature or provide an insulative coating or layer on which a second electronic feature (or a second portion of the first electronic feature) may be formed. By forming polyimide coatings in this manner, complex multi-layered electronic features may be formed. The polyimide coatings have the added advantage of being able to withstand the elevated temperatures that may be necessary to form one or more printable electronic features thereon.

In one aspect, for example, the process comprises the steps of: providing a substrate having a first surface; depositing a polyimide precursor ink comprising a polyimide precursor on at least a portion of the first surface; converting the polyimide precursor to a polyimide on the first surface; and forming an electronic feature on the polyimide. This process may be employed to planarize a substrate surface (the first surface) and/or to modify a substrate surface by providing a polyimide surface having predictable surface properties, on which an electronic feature may be formed.

In another embodiment, the invention is to a process for encapsulating a printed electronic feature with a polyimide encapsulation layer. In one aspect, the process includes the steps of: providing at least a portion of a first electronic feature on a substrate, the first electronic feature having a feature surface; depositing a polyimide precursor ink comprising a polyimide precursor on at least a portion of the feature surface; and converting the polyimide precursor to a polyimide on the at least a portion of the feature surface.

As used herein, the term “lateral” means a direction substantially parallel to a substrate surface and the term “longitudinal” means a direction substantially perpendicular to the substrate surface. The term “proximal” means the longitudinal direction extending toward the substrate surface, and the term “distal” means the longitudinal direction extending away from the substrate surface. As used herein, the terms “coating” and “layer” are used interchangeably to refer to a layer of material covering all or a portion of something else (e.g., a substrate).

### II. Polyimide Precursor Ink Compositions

As discussed in more detail below, in various embodiments, the present invention is directed to modifying a substrate surface (optionally planarizing the substrate surface or encapsulating an electronic feature) by forming a polyimide coating on the substrate surface and/or on an electronic feature that may be disposed on the substrate surface. The process comprises a step of applying a polyimide precursor ink (e.g., planarizing agent or encapsulating agent), which comprise a polyimide precursor, onto a substrate surface. The applied polyimide precursor ink is then treated to convert the polyimide precursor to a polyimide coating. The resulting polyimide coating formed from the polyimide precursor preferably is substantially non-conductive so that it does not interfere with any electronic features associated therewith.

The composition and properties of the polyimide precursor ink will vary widely depending, for example, on the deposition process selected and the desired properties for the ultimately formed polyimide coating. To be suitable for ink-jet application, the polyimide precursor ink preferably has a viscosity of less than about 100 centipoise, e.g., less than about 50 centipoise or less than about 40 centipoise. The surface tension of the polyimide precursor ink for ink-jet applications preferably ranges from about 15 dynes/cm to about 72 dynes/cm (e.g., from about 20 to about 60 dynes/cm or from about 25 to about 50 dynes/cm).

According to the present invention, the polyimide precursor ink comprises a polyimide precursor, preferably a polyamic acid or ester, and a vehicle. Additionally, the polyimide precursor ink optionally further comprises one or more of the following components: dielectric particulates (e.g., nanoparticles), a dielectric precursor (other than the polyimide precursor), a polymer (other than the polyimide precursor), a monomer, and/or one or more additives.

1. Polyimide Precursors

In a preferred embodiment, the polyimide precursor ink comprises one or more polyimide precursors, defined herein as compositions that may be converted chemically, to a polyimide coating. Preferably, the polyimide precursor comprises a polyamic acid or a polyamic ester. The generic chemical structure for polyamic acids and esters is as follows.

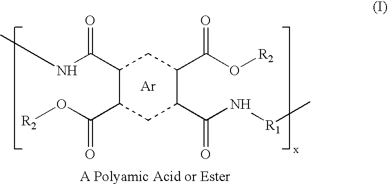

wherein

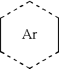

comprises any aromatic group, and x is an integer preferably greater than about 20, greater than about 40, greater than about 400 or greater than about 1000. Optionally, x ranges from about 20 to about 5000, e.g., from about 40 to about 400, or from about 400 to about 1000 or from about 1000 to about 4000. As used herein, the term “aromatic group” refers to an all-carbon monocyclic or fused-ring polycyclic (i.e., rings which share adjacent pairs of carbon atoms) groups of 6 to 14 carbon atoms having a completely conjugated pi-electron system. For example,

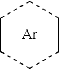

is optionally selected from the group consisting of: phenyl, naphthalenyl, anthracenyl and biphenyl. For structure (I) to constitute a polyamic acid, R₂ comprises H. For structure (I) to constitute a polyamic ester, R₂ comprises any group other than H. For example, R₂ optionally is selected from the group consisting of an alkyl group (such as methyl, ethyl, propyl, and the like), an alkenyl group (such as ethenyl, 1-propenyl, 2-propenyl, 1-, 2-, or 3-butenyl, and the like), and an alkynyl group (such as acetylene, ethnyl, propynyl, butynyl, or pentnyl, and the like). R₂ preferably comprises an alkyl group. R₁ optionally is selected from the group consisting of an alkyl group (such as methyl, ethyl, propyl, and the like), an alkenyl group (such as ethenyl, 1-propenyl, 2-propenyl, 1-, 2-, or 3-butenyl, and the like), an alkynyl group (such as acetylene, ethnyl, propynyl, butynyl, or pentnyl, and the like), and an aromatic group (such as phenyl, naphthalenyl, anthracenyl and biphenyl). R₁ preferably comprises an alkyl group.

The polyimide precursor, e.g., polyamic acid or polyamic ester, preferably is capable of being converted to a polyimide, which may be represented by the following structure:

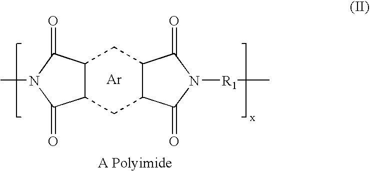

wherein

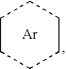

x and R₁ are defined above with reference to structure (I).

The composition and properties of the polyimide precursor, e.g., polyamic acid or polyamic ester, may vary widely. Preferably, the polyimide precursor, e.g., polyamic acid or polyamic ester, has a molecular weight on the order of from about 10,000 to about 10,000,000 amu, e.g., from about 10,000 to about 1,000,00 amu or from about 10,000 to about 100,000 amu. The polyimide precursor optionally has a dielectric constant (1 kHz) ranging from about 2 to about 6, e.g., from about 2.7 to about 5.3 or from about 3.1 to about 3.5.

The amount of polyimide precursor contained in the polyimide precursor ink may vary widely depending, for example, on the type of desired application process, and other factors. In various embodiments, the polyimide precursor ink optionally comprises the polyimide precursor, e.g., polyamic acid or ester, in an amount greater than about 1 weight percent, e.g., greater than about 5 weight percent or greater than about 10 weight percent, based on the total weight of the polyimide precursor ink. In terms of upper range limits, optionally in combination with the lower range limits, the polyimide precursor ink optionally comprises the polyimide precursor in an amount less than about 75 weight percent, e.g., less than about 50 weight percent or less than about 30 weight percent, based on the total weight of the polyimide precursor ink. In terms of ranges, the polyimide precursor ink optionally comprises the polyimide precursor in an amount from about 1 to about 50 weight percent, e.g., from about 5 to about 50 or from about 10 to about 30 weight percent, based on the total weight of the polyimide precursor ink.

2. Liquid Vehicle

Typically, the polyimide precursor ink comprises a liquid vehicle in addition to the polyimide precursor. As used herein, the term “vehicle” means a flowable medium that facilitates deposition of the ink, such as by imparting sufficient flow properties and supporting any optional dispersed particles, e.g., dispersed dielectric particles. The liquid vehicle may act as a solvent to one or more components contained in the polyimide precursor ink, and/or as a carrier to one or more particulates, e.g., as an emulsion. In a preferred embodiment, the liquid vehicle comprises one or more solvents in which the polyimide precursor, e.g., a polyamic acid or ester, is dissolved.

The liquid vehicle preferably comprises an organic solvent, optionally in combination with water. The selected solvent preferably is capable of solubilizing the polyimide precursor, e.g., polyamic acid or ester, to a high level. A low solubility of the polyimide precursor in the solvent may lead to low yields of the ultimately formed polyimide coating, thin deposits and poor planarization. In one aspect, the polyimide precursor ink of the present invention exploits combinations of solvents and polyimide precursor(s) that advantageously provide high solubility of the polyimide precursor while still allowing low temperature conversion of the polyimide precursor to the corresponding polyimide.

The liquid vehicle (e.g., solvent and/or carrier composition) can be polar or non-polar. Solvents that are useful according to the present invention include keto-pyrroles (e.g., N-methyl-2-pyrrolidone (NMP)), amines, amides (e.g., dimethyl acetamide (DMAc) or dimethyl formamide (DMF)), alcohols, ethers (e.g., ethylene glycol mono-n-butyl ether or diethylene glycol methyl ethyl ether) lactones (e.g., γ-butyrolactone), sulfoxides (e.g., dimethyl sulfoxide (DMSO)), water, ketones, unsaturated hydrocarbons, saturated hydrocarbons, mineral acids organic acids and bases, and combinations thereof. Preferably, the vehicle is selected from the group consisting of: N-methyl-2-pyrrolidone (NMP), dimethyl acetamide (DMAc), dimethyl formamide (DMF), gamma-butyrolactone, and dimethyl sulfoxide (DMSO), including various mixtures thereof. Other preferred organic solvents according to the present invention include diethyleneglycol butylether (DEGBE) and ethanolamine.

The amount of vehicle in the polyimide precursor ink may vary depending, for example, on the size of the particles, if any, in the ink and on the desired viscosity of the polyimide precursor ink. As non-limiting examples, the polyimide precursor ink optionally comprises the liquid vehicle (e.g., solvent and/or carrier medium) in an amount from about 20 to about 99 weight percent, e.g., from about 30 to about 95 weight percent or from about 40 to about 70 weight percent, based on the total weight of the first ink.

Examples of ink-jet liquid vehicle compositions are disclosed in U.S. Pat. No. 5,853,470 by Martin et al.; U.S. Pat. No. 5,679,724 by Sacripante et al.; U.S. Pat. No. 5,725,647 by Carlson et al.; U.S. Pat. No. 4,877,451 by Winnik et al.; U.S. Pat. No. 5,837,045 by Johnson et al.; and U.S. Pat. No. 5,837,041 by Bean et al. Each of the foregoing U.S. patents is incorporated by reference herein in their entirety.

3. Dielectric Particles

In one embodiment, the polyimide precursor ink further comprises a dielectric powder (having a high or low dielectric constant) in addition to the polyimide precursor. Preferred dielectric powders (nanoparticles or micron-size particles) include BaTiO₃, lead manganese niobate (PMN), lead zirconium titanate (PZT), doped barium titanate (BTO), barium neodymium titanate (BNT), lead tantalate (Pb₂Ta₂O₇), and other pyrochlores. Preferred insulative powders include TiO₂, SiO₂, and insulating glasses. Preferred insulative phase precursors include organic titanates such as titanium bis(ammonium lactato)dihydroxide; mixed alkoxo titanium carboxylates such as dimethoxy titanium bis(neodecanoate) or dibutoxy titanium bis(neodecanoate); silicon alkoxides such as silicon methoxide and silicon ethoxide. One benefit of including a dielectric powder in the polyimide precursor ink is that the dielectric powder could improve the dielectric properties of the ink, as well as improve the hardness and adhesion of the ink to the substrate.

4. Additives

Additives that may be included in the polyimide precursor ink include crystallization inhibitors, adhesion promoters, rheology modifiers, among others.

The polyimide precursor ink may also include a crystallization inhibitor in order to form an amorphous substantially non-conductive film. A preferred crystallization inhibitor is lactic acid. Such inhibitors reduce the formation of large crystallites directly from the dielectric precursor, which can be detrimental. Other crystallization inhibitors include ethylcellulose and polymers such as styrene allyl alcohol (SAA) and polyvinyl pyrollidone (PVP). In other cases, small amounts of glycerol can act as a crystallization inhibitor. Other compounds useful for reducing crystallization are other polyalcohols such as malto dextrin, sodium carboxymethylcellulose and TRITON X100. In general, solvents with a higher melting point and lower vapor pressure inhibit crystallization of any given compound more than a lower melting point solvent with a higher vapor pressure. In one embodiment, not greater than about 10 weight percent crystallization inhibitor as a percentage of total composition is added, preferably not greater than 5 weight percent and more preferably not greater than 2 weight percent.

The polyimide precursor ink can also include an adhesion promoter adapted to improve the adhesion of the deposited polyimide precursor ink and/or of the resulting polyimide coating on the underlying substrate.

The polyimide precursor ink described herein optionally includes one or more rheology modifiers, for example, to reduce spreading on the substrate. Rheology modifiers include SOLTHIX 250 (Avecia Limited), SOLSPERSE 21000 (Avecia Limited), styrene allyl alcohol (SAA), ethyl cellulose, carboxy methylcellulose, nitrocellulose, polyalkylene carbonates, ethyl nitrocellulose, and the like. These additives can reduce the spreading after deposition. Surfactants and wetting agents may also be used, as they can also help control spreading.

The polyimide precursor ink can also include other additives such as wetting angle modifiers, humectants and the like.

### III. Processes for Forming Polyimide Layers on Substrates

According to one aspect of the present invention, the invention is to a process for forming a polyimide layer on a substrate and preferably forming an electronic feature thereon. In one embodiment, for example, the invention is to a process comprising the steps of: (a) providing a substrate having a first surface; (b) depositing a polyimide precursor ink comprising a polyimide precursor on at least a portion of the first surface; (c) converting the polyimide precursor to a polyimide on the first surface; and (d) forming an electronic feature on the polyimide.

A. Depositing of the Polyimide Precursor Ink

The polyimide precursor ink may be deposited onto a substrate surface using a variety of tools such as, e.g., low viscosity deposition tools. As used herein, a low viscosity deposition tool is a device that deposits an ink onto a surface by ejecting the ink through an orifice toward the surface without the tool being in direct contact with the surface. The low viscosity deposition tool is preferably controllable over an x-y grid, referred to herein as a direct-write deposition tool. A preferred direct-write deposition tool according to the present invention is an ink-jet device, e.g., a piezo-electric, thermal, drop-on-demand or continuous ink jet device. Other examples of direct-write deposition tools include aerosol jets and automated syringes, such as the MICROPEN tool, available from Ohmcraft, Inc., of Honeoye Falls, N.Y.

A preferred direct-write deposition tool for the purposes of the present invention is an ink-jet device. Ink-jet devices operate by generating droplets of the composition and directing the droplets toward a surface. The position of the ink-jet head is carefully controlled and can be highly automated so that discrete patterns of the composition can be applied to the surface. Ink-jet printers are capable of printing at a rate of about 1000 drops per jet per second or higher and can print linear features with good resolution at a rate of about 10 cm/sec or more, up to about 1000 cm/sec. Each drop generated by the ink-jet head includes approximately 3 to about 100 picoliters of the composition, which is delivered to the surface. For these and other reasons, ink-jet devices are a highly desirable means for depositing materials onto a surface.

Optionally, the ink-jet device includes an ink-jet head with one or more orifices having a diameter of not greater than about 100 μm, such as from about 50 μm to about 75 μm. Droplets are generated and are directed through the orifice toward the surface being printed. Ink-jet printers typically utilize a piezoelectric driven system to generate the droplets, although other variations are also used. Ink-jet devices are described in more detail in, for example, U.S. Pat. Nos. 4,627,875 and 5,329,293, the entireties of which are incorporated herein by reference.

In another embodiment, a thermal ink jet printing device is used to deposit the polyimide precursor ink. In thermal ink jet printing, a print cartridge is employed having a series of tiny electrically-heated chambers. The printer runs a pulse of current through the heating elements, which causes a steam explosion in the chamber. The explosion forms a bubble, which propels a droplet of ink onto the target substrate. When the bubble condenses, surplus ink is sucked back up from the printing surface. The ink's surface tension pumps another charge of ink into the chamber through a narrow channel attached to an ink reservoir.

The polyimide precursor ink can also be deposited by aerosol jet deposition. In aerosol jet deposition, the polyimide precursor ink is aerosolized into droplets and the droplets are transported to the substrate in a flow gas through a flow channel. Typically, the flow channel is straight and relatively short. Examples of tools and methods for the deposition of fluids using aerosol jet deposition include those disclosed in U.S. Pat. Nos. 6,251,488; 5,725,672 and 4,019,188, the entire disclosures whereof are incorporated by reference herein.

The polyimide precursor ink of the present invention can also be deposited by a variety of other techniques including pen/syringe, continuous or drop on demand ink-jet, intaglio, flexographic printing, roll printer, spraying, dip coating, spin coating, and other techniques that direct discrete units of fluid or continuous jets, or continuous sheets of fluid to a surface. Other examples of advantageous printing methods for the compositions of the present invention include lithographic printing and gravure printing. For example, gravure printing can be used with electronic inks having a viscosity of up to about 5,000 centipoise. The gravure method can deposit the polyimide precursor ink at a high rate of speed, such as up to about 700 meters per minute.

B. Treating the Applied Polyimide Precursor Ink

The polyimide precursors employed in the present invention preferably can be converted at relatively low temperatures, e.g., less than about 300° C., to form high performance polyimide dielectric features. As indicated above, the polyimide precursor preferably comprises a polyamic acid or ester. After deposition onto a substrate, the polyimide precursor ink, e.g., planarization agent or encapsulation agent, preferably is pretreated at a relatively low elevated temperature in order to remove a majority, e.g., at least about 50 weight percent, at least about 75 weight percent, or at least about 80 weight percent of the vehicle that was contained in the ink, without converting (or minimally converting) the polyimide precursor to a polyimide.

The pretreating optionally comprises heating the deposited polyimide precursor ink to a maximum pretreating temperature for a pretreating time period. The maximum pretreating temperature preferably ranges from about 25 to about 100° C., e.g., from about 40 to about 90° C., or from about 50 to about 80° C. The pretreating time period depends primarily on the solvents employed and the amount of solvent contained in the polyimide precursor ink. Optionally, the pretreating time period ranges from about 1 to about 60 minutes, e.g., from about 1 to about 30 minutes or from about 5 to about 10 minutes.

Preferably, after at least about 50 weight percent (e.g., at least about 80 wt. %, at least about 90 wt. % or at least about 95 wt. %) of the vehicle has been removed from the deposited polyimide precursor ink during the pretreating step, the remaining polyimide precursor ink (which optionally comprises primarily the polyimide precursor, e.g., polyamic acid or polyamic ester) is heated to a conversion temperature under conditions effective for the polyimide precursor to be converted to a polyimide. The conversion temperature should be sufficiently high and sustained, as necessary, for a conversion time period sufficient to cause a weight majority (e.g., greater than 50 wt. %, greater than about 75 wt. %, or greater than about 95 wt. %) of the polyimide precursor to be converted to a polyimide. The conversion temperature should be greater than the maximum pretreating temperature. For example, the conversion temperature optionally ranges from about 150 to about 400° C., e.g., from about 200 to about 350° C., from about 250 to about 350° C. or from about 300 to about 320° C. The conversion time period depends primarily on the reactivity of the polyimide precursor. Optionally, the conversion time period ranges from about 1 to about 60 minutes, e.g., from about 10 to about 40 minutes or from about 20 to about 40 minutes. After the conversion time period, the temperature of the converted ink (meaning the ink after a majority of the polyimide precursor has been converted to polyimide) is cooled, e.g., to room temperature.

If the polyimide precursor comprises a polyamic acid, then the polyamic acid is preferably converted to a polyimide through a dehydration reaction. Without limiting the invention to any particular reaction or reaction mechanism, an amide group from a polyimide precursor reacts with a neighboring carboxylic acid group in the same or different polyimide precursor monomer unit to form a heterocyclic, preferably aromatic, imide group and water. Since the conversion reaction occurs at elevated temperatures, the water formed during the dehydration reaction is typically liberated to the atmosphere in the form of water vapor.

If the polyimide precursor comprises a polyamic ester, then the polyamic ester is converted to a polyimide through a reaction that forms an alcohol, R₂OH, in addition to a polyimide. Without limiting the invention to any particular reaction or reaction mechanism, an amide group from a polyimide precursor reacts with a neighboring ester group in the same or different polyimide precursor monomer unit to form a heterocyclic, preferably aromatic, imide group and alcohol R₂OH. Since the conversion reaction occurs at elevated temperatures, the alcohol formed during the dehydration reaction is ideally liberated to the atmosphere in gaseous form.

Without limiting the invention to any particular reaction or reaction mechanism, the conversion of a polyamic acid or polyamic ester to its corresponding polyimide may be represented by the following non-limiting reaction:

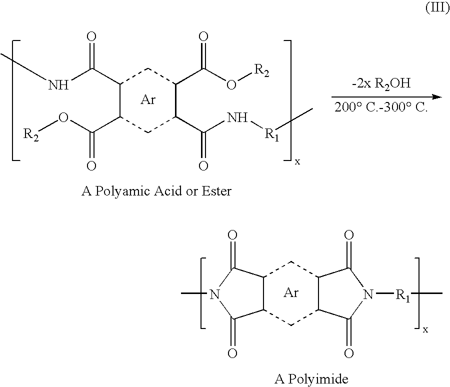

The composition and properties of the resulting polyimide coating may vary widely. In one aspect, the polyimide coating comprises a polyimide in an amount greater than about 50 wt. %, greater than about 80 wt. %, greater than about 95 wt. % or greater than about 99 wt. %.

Preferably, the polyimide has a molecular weight on the order of from about 10,000 to about 1,000,000 amu, e.g., from about 10,000 to about 500,000 amu or from about 100,000 to about 500,000 amu. The glass transition temperature of the polyimide should be sufficiently high such that it does not break down during formation of additional features, e.g., on top of the planarizing feature.

Preferably, the polyimide has a glass transition temperature greater than about 250° C., greater than about 350° C., greater than about 400° C. or greater than about 500° C. In terms of ranges, the glass transition temperature of the polyimide optionally ranges from about 250 to about 600° C., e.g., from about 300 to about 500° C., or from about 350 to about 500° C.

The polyimide coating optionally has a dielectric constant (1 kHz) that is greater than about 5, e.g., greater than about 4, greater than about 3 or greater than about 2. In terms of ranges, the polyimide coating optionally has a dielectric constant (1 kHz) that ranges from about from about 2 to about 6, e.g., from about 2.7 to about 5.3 or from about 3.1 to about 3.5.

The thickness of the polyimide coating also may vary depending primarily on the concentration of the polyimide precursor in the ink and the volume of ink deposited. The thickness of the ultimately formed polyimide coating optionally ranges from about 0.2 to about 20 μm, e.g., from about 0.5 to about 10 μm or from about 1 to about 5 μm. In other embodiments, the thickness of the ultimately formed polyimide coating may be greater ranging, for example, from about 5 to about 30 μm, e.g., from about 10 to about 20. It is also contemplated that thicker polyimide coating layers may be formed, for example, by depositing (e.g., printing) the polyimide precursor ink onto a substrate surface in multiple passes and optionally treating the deposited polyimide precursor ink between passes. In this manner, the polyimide coating may be built up to a desired thickness. Utilizing this procedure, polyimide coatings having thicknesses greater than about 0.2 μm, e.g., greater than about 1 μm or even greater than 10 μm may be formed.

As indicated above, the polyimide precursor ink optionally comprises dielectric particles (nano). During formation of the polyimide coating from the polyimide precursor in the polyimide precursor ink, the dielectric particles preferably fuse to adjacent dielectric particles to form a network of interconnected dielectric nodes. The degree to which the particles are interconnected to one another depends largely on the treating conditions implemented and the concentration of the dielectric particles in the polyimide precursor ink. Under mild treating conditions (e.g., low temperatures), a porous network of necked dielectric nodes may be formed. Porosity can be monitored and measured by Nitrogen BET (Brunauer, Emmett and Teller), Mercury porosimetry, or DBP methods. Under limited circumstances, porosity may be desired as air acts as a generally good insulator. Under harsher treating conditions (e.g., higher temperatures), a substantially nonporous planarizing feature may be formed.

The incorporation of porosity may be detrimental to the performance of these layers as a result of the high internal surface area and the contribution of the dielectric properties of the material trapped inside the pores, especially air. Therefore, porosity typically should be reduced to a minimum. The porosity can be minimized by, e.g, heating the polyimide precursor ink during the formation of the polyimide coating at a rate that is slow enough so as to avoid the formation of gas (e.g., air) bubbles within the film

After formation of the polyimide coating, it may be desired to form an electronic feature thereon. Thus, in one embodiment, the process further comprises the steps of: applying a first ink onto at least a portion of the polyimide, and treating the first ink under conditions effective to form at least a portion of the electronic feature. Various possible compositions and treating conditions for formation of electronic features from the first ink are discussed below.

C. Planarization Utilizing Polyimide Precursor Inks

As indicated above, one problem associated with the formation of printable electronic features is substrate variability. Although many substrates provide substantially planar surfaces on a macroscopic scale, such surfaces often possess surface irregularities on a microscopic scale. As used herein, the term “surface irregularities” means features or characteristics, which impart a non-planar form to a substrate. Surface irregularities may be an inherent property of the substrate material itself, or they may be formed by the intentional formation of a feature on a substrate.

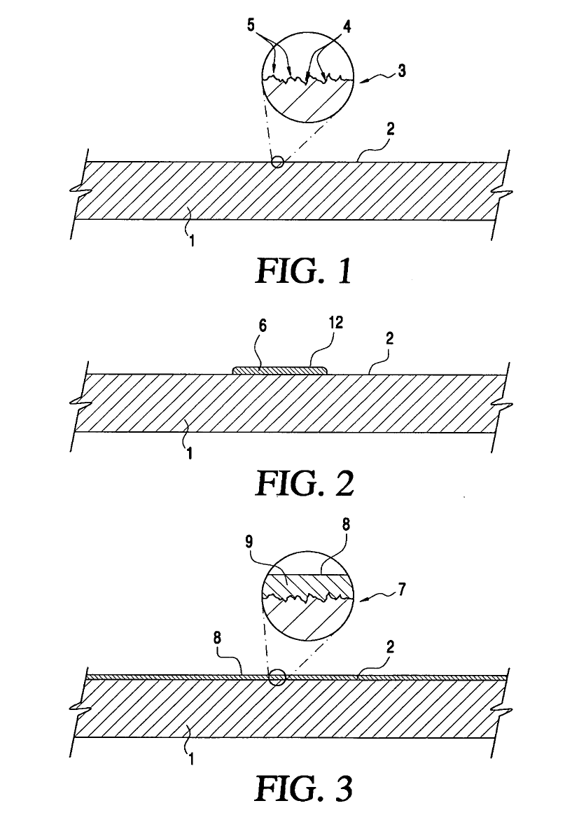

FIG. 1, for example, illustrates surface irregularities that are inherent to a particular substrate material. As shown, FIG. 1 illustrates a substrate, generally designated 1, having a substantially planar surface 2. Although the substantially planar surface 2 appears very planar on a macroscopic scale, the surface actually includes many surface irregularities, as shown by magnified inset 3. Specifically, the surface irregularities shown in FIG. 1 include peaks 5 and valleys 4 arranged in a highly disordered, random manner.

The presence of such surface irregularities may be problematic for providing printable electronic features having predictable electronic properties. Specifically, as one or more electronic inks are applied to a substrate such as substrate 1 shown in FIG. 1, a portion of the electronic ink will fill the valleys 4, resulting in waste. Additionally, peaks 5 may undesirably extend into the ultimately formed electronic feature thereby undesirably and unpredictably modifying the electrical characteristics thereof.

FIG. 2 illustrates an intentionally formed surface irregularity. Specifically, the surface irregularity shown in FIG. 2 is an electronic feature 6 disposed on the surface 2 of base substrate 1. The electronic feature 6 has an electronic feature surface 12, which is shown extending in a laterally extending plane parallel to surface 2 of base substrate 1. The electronic feature 6 may be a conventional non-printed electronic feature or, alternatively, a printed electronic feature. In either case, it may be desired to form a second electronic feature, e.g., a printed electronic feature, in a separate laterally extending plane, distally oriented with respect to the first electronic feature 6. That is, it may be desired to form a multi-layer electronic feature or features. In order to form such a multi-layer electronic feature, it may be desired to planarize an underlying substrate in order to render it suitable for receiving a subsequent layer. Collectively, the electronic feature 6 and the base substrate 1 form the “first substrate,” which may be planarized according to the present invention. In other words, the first substrate comprises the base substrate 1 and a preformed electronic feature 6 disposed thereon, the preformed electronic feature forming at least a portion of the surface irregularity.

In a preferred embodiment, the above-described polyimide precursor ink is deposited on a substrate having a surface irregularity, and the deposited polyimide precursor ink is treated, as discussed above, under conditions effective to convert the polyimide precursor in the deposited polyimide precursor ink to a polyimide coating, which acts as a polyimide planarizing feature having a more planar surface than the underlying substrate surface on which it was formed.

FIG. 3 illustrates a substrate 1 having a surface 2 with many surface irregularities in the form of microscopic peaks and valleys. The substrate 1 has been planarized with a polyimide precursor ink to form a polyimide planarizing feature 9, which comprises a polyimide layer formed from the polyimide precursor derived from the polyimide precursor ink. The dielectric nature of the polyimide layer formed on the substrate 1 preferably does not interfere with the electrical characteristics of one or more electronic features, not shown, which features are subsequently applied onto the planarized substrate. The polyimide planarizing feature 9 preferably has a highly planar surface 8, which is more planar than the substantially planar surface 2 of the substrate 1. In another embodiment, not shown, the polyimide layer formed from the polyimide precursor ink does not improve overall planarity (and hence cannot be referred to as a planarizing agent), but it provides a uniform predictable surface on which electrical features may be formed.

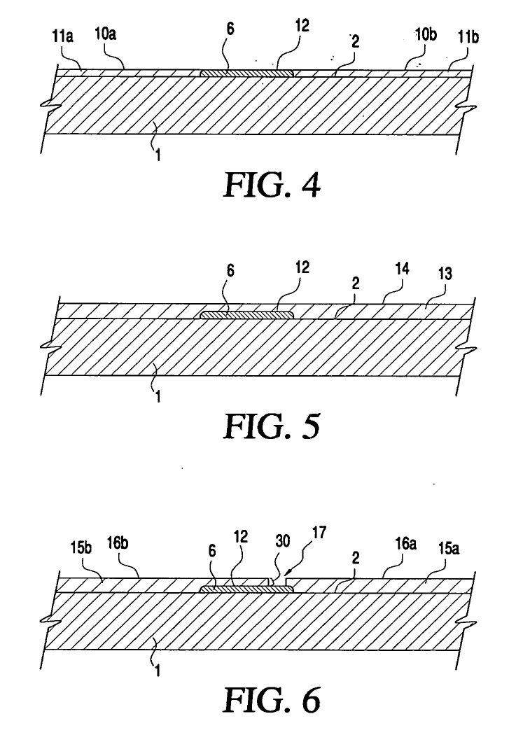

If the surface irregularity comprises an electronic feature, as shown in FIG. 2, then the polyimide precursor ink (as planarizing agent) preferably is applied to the substrate surface adjacent to (laterally with respect to) the preformed electronic feature in the applying step. Additionally, the thickness of the polyimide precursor ink preferably is sufficient to form a polyimide planarizing feature comprising a polyimide adjacent to the surface irregularity formed by the electronic feature. Depending on the degree to which the electronic feature extends distally with respect to the substrate surface, it may be necessary to apply the polyimide precursor ink to the substrate in a plurality of passes, and optionally treating the deposited ink between passes. In a preferred embodiment, the polyimide precursor ink is applied in an amount sufficient to ultimately form a polyimide planarizing feature having a planar surface that is aligned with the surface of the electronic feature, if any. That is, the planar surface of the polyimide planarizing feature preferably is in the same laterally extending plane as the surface of the electronic feature, if any. Thus, the planar surface of the polyimide planarizing feature in combination with the surface of the electronic feature forms a composite surface on which a subsequent layer optionally may be applied. This aspect of the invention is shown in FIG. 4.

As shown, FIG. 4 illustrates an electronic feature 6 disposed on surface 2 of base substrate 1. The electronic feature 6 has an electronic feature surface 12, shown extending in a laterally extending plane that is parallel with surface 2 of base substrate 1. In this aspect, the electronic feature 6 in combination with the base substrate 1 constitutes a “first substrate” having a surface irregularity formed by the electronic feature 6. As shown, the first substrate has been planarized with a polyimide precursor ink as planarizing agent to form polyimide planarizing features 11a and 11b disposed on the surface 2 of base substrate 1. The polyimide planarizing features 11a and 11b form highly planar surfaces 10a and 10b, respectively. As shown, the highly planar surfaces 10a and 10b form laterally extending planar surfaces that are aligned (laterally) with respect to electronic feature surface 12. That is, the highly planar surfaces 10a and 10b lie substantially in the same geometric plane as the electronic feature surface 12 of the electronic feature 6. Thus, in this embodiment of the present invention, a composite planar surface is formed, which comprises the highly planar surfaces 10a and 10b of polyimide planarizing features 11a and 11b in combination with electronic feature surface 12 of preformed electronic feature 6. Optionally, one or more secondary electronic features, not shown, may be formed, e.g., by an ink-jet printing process, on top of (or distally with respect to) this composite planarized surface.

For planarization purposes, it is important that the polyimide precursor ink be applied in an amount sufficient to form a polyimide planarizing feature having a planar surface that is more planar that the first surface of the first substrate (prior to application of the polyimide precursor ink). Additionally, as one skilled in the art would appreciate, the thickness of the applied polyimide precursor ink typically will not reflect the thickness of the ultimately formed polyimide planarizing feature (post treatment). Accordingly, it is important to take into account the relative percentage of components contained in the polyimide precursor ink that will ultimately form the polyimide planarizing feature after treatment of the applied polyimide precursor ink. For example, if the polyimide precursor ink comprises a liquid vehicle that is removed (vaporized) during the treating step to form a polyimide planarizing feature, the volume of polyimide precursor ink that should be applied will be greater than the volume of the polyimide planarizing feature ultimately formed. Accordingly, it is necessary to calculate the amount of polyimide precursor ink that is necessary to be applied to a substrate surface in order to form a polyimide planarizing feature having a desired thickness. Such calculations are well within the purview of those skilled in the art.

### IV. Processes for Encapsulating Electronic Features

As indicated above, in another aspect, the invention is to a process for forming an encapsulated electronic feature. In this embodiment, the polyimide layer or coating, described above, acts to encapsulate an electronic feature. In a related embodiment, the invention is to a process for forming a multi-layer security feature by encapsulating an electronic feature with a polyimide layer and by forming a second electronic feature (or a second portion of the encapsulated electronic feature) on top of the polyimide layer. That is, the polyimide layer or coating, described above, may be used to separate adjacent conductive features in a multi-layered complex electronic feature.

In this embodiment, the invention comprises the steps of: (a) providing at least a portion of a first electronic feature on a substrate, the first electronic feature having a feature surface; (b) depositing, e.g., through a direct write printing process, a polyimide precursor ink comprising a polyimide precursor on at least a portion of the feature surface; and (c) converting the polyimide precursor to a polyimide on the at least a portion of the feature surface. Optionally, the process further comprises the step of depositing a second ink on at least a portion of the polyimide. The deposited second ink optionally is then treated under conditions effective to form at least a portion of a second electronic feature.

This embodiment of the present invention is substantially similar to the above described planarization aspect of the present invention. The primary difference is that by encapsulating an electronic feature, at least a portion of the electronic feature is covered (longitudinally) by a polyimide encapsulating layer, while planarizing entails forming planarization features in the absence of an electronic feature (see FIG. 3) and/or adjacent (laterally) to an electronic feature (see FIG. 4) in order to form a highly planar surface on which another electronic feature may be formed.

The purpose for encapsulating an electronic feature also is different than the purpose for forming a planarizing feature. The primary purpose for encapsulating an electronic feature is to protect the feature (or portion thereof) from atmospheric degradation. As indicated above, oxygen and water vapor may degrade an electronic feature. By encapsulating the electronic feature with an encapsulation layer, however, a barrier is formed, which inhibits contacting of atmospheric air and/or water with the underlying electronic feature. Of course, some degree of planarization may be achieved by encapsulating an electronic feature.

FIG. 5 illustrates a polyimide-encapsulated electronic feature 6 disposed on surface 2 of base substrate 1. The electronic feature 6 has an electronic feature surface 12, shown extending in a laterally extending plane that is parallel with surface 2 of base substrate 1. As shown, the electronic feature 6 is fully encapsulated by a polyimide encapsulation layer 13. The polyimide encapsulation layer 13 optionally has a highly planar surface 14. Since the electronic feature 6 is fully encapsulated, atmospheric degradation of the electronic feature 6 desirably is inhibited. Optionally, one or more secondary electronic features, not shown, may be formed, e.g., by an ink-jet printing process, on top of (or distally with respect to) the highly planar surface 14.

Additionally, polyimide encapsulation layers having conductive vias may be formed according to the present invention. Such encapsulation layers are highly desirable in that they can protect a proximally oriented first electronic feature from atmospheric degradation while simultaneously providing a means for allowing the first electronic feature to conductively communicate with a distally oriented second electronic feature. The polyimide encapsulation layer also desirably insulates longitudinally situated electronic components (e.g., situated in longitudinally parallel planes from one another) from one another in regions where conductive communication is not desired. FIGS. 6-8 illustrate the formation of an encapsulating layer that includes a via connecting longitudinally adjacent electronic features to one another.

FIG. 6 illustrates a partially encapsulated electronic feature 6 disposed on surface 2 of base substrate 1. The electronic feature 6 has an electronic feature surface 12, shown extending in a laterally extending plane that is parallel with surface 2 of base substrate 1. As shown, the electronic feature 6 is partially encapsulated by polyimide encapsulation layers 15a and 15b having planar surfaces 16a and 16b. Encapsulation layers 15a and 15b are separated from one another by a void 17. Void 17 may be formed, for example, by modifying the timing of the deposition of an ink-jet printing head. Thus, in one aspect, the encapsulation agent is selectively applied to at least a portion of a first electronic feature in the applying step to form a void in the encapsulation layer. Alternatively, void 17 may be formed by etching, lasing or chemically treating a fully encapsulating layer, as shown, for example in FIG. 5.

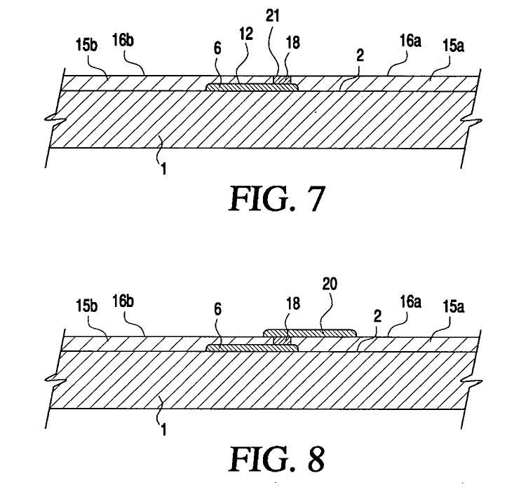

Preferably, an electronic ink (in this aspect, referred to as a “via ink”) is deposited in the void, e.g., through a printing process, preferably a direct write printing process such as ink-jet printing. In order to minimize bleeding between the encapsulating agent and the electronic ink, it is preferred that the encapsulating agent be treated to form the encapsulating layers 15a and 15b prior to deposition of the electronic ink into void 17. The deposited electronic ink may then be treated, as discussed above, to form an electronic feature, e.g., via 18, in void 17, as shown in FIG. 7. Thus, in one aspect, the encapsulation process further comprises the steps of applying a via ink to at least a portion of the void 17, and treating the applied via ink under conditions effective to form a via 18.

The dimensions of void 17 may vary widely depending on the desired size of the via that is ultimately to be formed within the void. In various embodiments, the narrowest lateral distance between the polyimide encapsulation layers 15a and 15b (e.g., the longitudinal distance formed by the void) ranges from about 10 μm to about 300 μm, e.g., from about 20 μm to about 200 μm or from about 50 μm to about 100 μm. Similarly, the thickness 30 of the portion of the polyimide encapsulation layer that longitudinally covers a portion of electronic feature 6 may vary widely. In various embodiments, the thickness ranges from about 2 μm to about 50 μm, e.g., from about 5 μm to about 25 μm or from about 10 μm to about 20 μm.

Reverting to FIG. 7, via 18 is shown having surface 21, which is longitudinally aligned in substantially the same plane as planar surfaces 16a and 16b. By forming via 18 having surface 21 in substantially the same plane as planar surfaces 16a and 16b of encapsulation layers 15a and 15b, a composite surface is formed on which a second electronic feature 20 may be formed, as shown in FIG. 8.

Thus, in a preferred aspect, the process further comprises the step of applying a second ink on at least a portion of the polyimide encapsulation layer(s) 15a and/or 15b. Additionally, the process optionally further comprises the step of treating the second ink under conditions effective to form at least a portion of a second electronic feature 20, as shown in FIG. 8. As shown, the second electronic feature 20 is electrically coupled to the first electronic feature 6 by the via 18. Optionally, the steps of treating the via ink and of treating the second ink occur simultaneously, e.g., in a single treating step. Alternatively, the steps occur sequentially.

In another embodiment, the electronic feature 6 and the electronic feature 20 are portions of a first electronic feature (e.g., of an active electronic feature). In this aspect, the process optionally further comprises the steps of treating the second ink under conditions effective to form a second portion (e.g., the electronic feature 20) of the first electronic feature, and the second portion is electrically coupled by the via to a first portion (e.g., the electronic feature 6) of the first electronic feature, the first portion being formed in the step of treating the first ink. As indicated above, the steps of treating the via ink and of treating the second ink optionally occur simultaneously, e.g., in a single treating step. Alternatively, the steps occur sequentially.

The step of treating the deposited polyimide precursor ink to form the encapsulation layer may be performed by any of the above-described process steps for converting the polyimide precursor in the polyimide precursor ink to a polyimide. Similarly, since it is formed from the same polyimide precursor ink and treated under the same conditions as described above, the polyimide encapsulation layer(s) formed by this process of the invention is substantially identical as the polyimide coating and layers, described above.

### V. Printing Electronic Features on Polyimide Coatings

As indicated above, in various embodiments, the processes of the invention include a step of printing or otherwise forming an electronic feature (or a portion thereof) on a polyimide coating. The polyimide coating may be in the form of a polyimide surface modifying layer, a polyimide planarizing feature or a polyimide encapsulating feature.

Printable electronic features and processes for printing electronic features from one or more inks are disclosed in, for example, Published U.S. Patent Application Nos. US2003/0161959 A1 filed on Nov. 1, 2002, US2003/0108664 A1 filed on Oct. 4, 2002, US2003/0124259 A1 filed on Oct. 4, 2002, US2003/0175411 A1 filed on Oct. 4, 2002, US2003/0180451 A1 filed on Oct. 4, 2002, US2003/0148024 A1 filed on Oct. 4, 2002, and co-pending U.S. patent application Ser. No. 11/331,239 filed Jan. 13, 2006, the entireties of which are incorporated herein by reference. The processes disclosed in the above-referenced patent applications relate to forming various electronic features from one or more electronic inks. As used herein, the term “electronic ink” means an ink suitable for printing, e.g., direct write printing, to form at least a portion of an electronic feature. According to this definition, an electronic ink may or may not allow for the flow of electrons, e.g., be conductive.

In various aspects, the electronic inks used to form printable electronic features may comprise a variety of different compositions. Electronic inks may include, for example, one or more of the following components: liquid vehicles, nanoparticles (metallic or non-metallic), anti-agglomeration agents, metal precursors, reducing agents, one or more additives and/or other components.

Electronic inks typically include a liquid vehicle. The liquid vehicle may act as a solvent to one or more components contained in the first ink and/or as a carrier to one or more particulates, e.g., as an emulsion. In a preferred embodiment, the liquid vehicle comprises a solvent in which the metal precursor is dissolved.

The liquid vehicle may comprise an aqueous-based solvent, an organic solvent or a combination thereof. Aqueous liquids may be preferred for use as the liquid vehicle in many situations because of their low cost, relative safety and ease of use. For example, water has the advantage of being non-flammable, and when vaporized during the formation of the particles does not tend to contribute to formation of byproducts that are likely to complicate processing or contaminate the ultimately resulting conductive features. Moreover, aqueous liquids are good solvents for a large number of metal precursors, although attaining a desired level of solubility for some materials may involve modification of the aqueous liquid, such as pH adjustment.

Optionally, the electronic ink comprises a metallic composition, preferably metallic nanoparticles, defined herein as particles having an average particle size (d50 value) of not greater than about 1 μm, preferably not greater than about 500 nm or not greater than 100 μm. In terms of ranges, the nanoparticles optionally have an average particle size of from about 10 to about 80 μm, e.g., from about 25 to about 75 nm, and are not substantially agglomerated. The solids loading of particles in the ink optionally is as high as possible without adversely affecting the viscosity or other necessary properties of the ink.

The metallic composition optionally comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead. In another aspect, the metallic composition comprises an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead.

In one aspect, the electronic ink comprises nanoparticles, and the electronic ink comprises an anti-agglomeration agent, which inhibits agglomeration of the nanoparticles. Due to their small size and the high surface energy associated therewith, nanoparticles usually show a strong tendency to agglomerate and form larger secondary particles (agglomerates). In one aspect of the invention, the nanoparticles comprise an anti-agglomerating agent, which inhibits agglomeration of the nanoparticles. Preferably, the nanoparticles are coated, at least in part, with the anti-agglomerating agent. The anti-agglomerating agent preferably comprises a polymer, preferably an organic polymer.

In several preferred embodiments, the polymer comprises a polymer of vinylpyrrolidone. More preferably, the polymer of vinylpyrrolidone comprises a homopolymer. In other aspects, the polymer of vinylpyrrolidone comprises a copolymer. The copolymer may be selected from the group consisting of a copolymer of vinylpyrrolidone and vinylacetate; a copolymer of vinylpyrrolidone and vinylimidazole; and a copolymer of vinylpyrrolidone and vinylcaprolactam.

The anti-agglomeration substance shields (e.g., sterically and/or through charge effects) the nanoparticles from each other to at least some extent and thereby substantially prevents direct contact between individual nanoparticles. The anti-agglomeration substance is preferably adsorbed on the surface of the metallic nanoparticles. The term “adsorbed” as used herein includes any kind of interaction between the anti-agglomeration substance and a nanoparticle surface (e.g., the metal atoms on the surface of a nanoparticle) that manifests itself in an at least (and preferably) weak bond between the anti-agglomeration substance and the surface of a nanoparticle. Preferably, the bond is a non-covalent bond, but still strong enough for the nanoparticle/anti-agglomeration substance combination to withstand a washing operation with a solvent that is capable of dissolving the anti-agglomeration substance. In other words, merely washing the metallic nanoparticles with the solvent at room temperature will preferably not remove more than a minor amount (e.g., less than about 10%, less than about 5%, or less than about 1%) of the anti-agglomeration substance that is in intimate contact with (and (weakly) bonded to) the nanoparticle surface. Of course, any anti-agglomeration substance that is not in intimate contact with a nanoparticle surface but merely accompanies the bulk of the nanoparticles (e.g., as an impurity/contaminant), i.e., without any significant interaction therewith, will preferably be removable from the nanoparticles by washing the latter with a solvent for the anti-agglomeration substance.

In another aspect, the electronic ink comprises a metal precursor to a metal. As used herein, a “metal precursor” is a compound comprising a metal and capable of being converted (e.g., through a reaction with a reducing agent and/or with the application of heat) to form an elemental metal corresponding to the metal in the metal precursor. “Elemental metal” means a substantially pure metal or alloy having an oxidation state of zero. In this aspect, the metal in the metal precursor optionally is selected from the group consisting of silver, gold, copper, nickel, cobalt, palladium, platinum, indium, tin, zinc, titanium, chromium, tantalum, tungsten, iron, rhodium, iridium, ruthenium, osmium and lead.

The electronic ink also optionally comprises a reducing agent to facilitate conversion of a metal in a metal precursor optionally contained in the ink (or derived form another ink) to its elemental form. The use of a reducing agent permits the processing temperature to be maintained below the melting temperature of the substrate, whereas the processing temperature may exceed those limits without use of the reducing agent. In various embodiments, the primary reducing agent is selected from the group consisting of alcohols, aldehydes, amines, amides, alanes, boranes, borohydrides, aluminohydrides and organosilanes.

A non-limiting list of exemplary additives that may be included in the first ink includes: crystallization inhibitors, polymers, polymer precursors (oligomers or monomers), binders, dispersants, surfactants, humectants, defoamers, pigments and the like.

The physical characteristics of electronic inks vary widely depending, for example, on the desired printing process to be used to apply the electronic ink. The electronic inks may be applied to a substrate by a variety of printing processes including intaglio printing, gravure printing, lithographic printing and flexographic printing. Other deposition techniques include roll printer, spraying, dip coating, spin coating, and other techniques that direct discrete units of fluid or continuous jets, or continuous sheets of fluid to a surface. In a preferred aspect, the electronic ink is applied by a direct write printing process, such as ink-jet printing, e.g., piezo-electric or thermal ink jet printing. For ink-jet printing applications, the electronic ink preferably has a viscosity of less than about 100 centipoise, e.g., less than about 50 centipoise or less than about 40 centipoise. The surface tension of the electronic ink for ink-jet applications preferably ranges from about 15 dynes/cm to about 72 dynes/cm (e.g., from about 20 to about 60 dynes/cm or from about 25 to about 50 dynes/cm).

Many processes are known for forming electronic features from the above-described electronic inks. In a preferred embodiment, at least a portion of the electronic feature is formed by a process comprising the steps of: (a) depositing an electronic ink comprising a liquid vehicle onto a substrate surface (e.g., onto a polyimide coating); and (b) removing the liquid vehicle, e.g., by heating, under conditions effective to form the at least a portion of the electronic feature. Heating rates for drying the electronic ink are preferably greater than about 10° C./min., more preferably greater than about 100° C./min. and even more preferably greater than about 1000° C./min. If the ink comprises metal nanoparticles, the nanoparticles may become sintered or fused together as the liquid vehicle is removed, thereby improving the conductivity of the feature.

In one aspect of the present invention, the deposited electronic ink may be converted to an electronic feature at temperatures of not higher than about 300° C., e.g., not higher than about 250° C., not higher than about 225° C., not higher than about 200° C., or even not higher than about 185° C. In many cases it will be possible to achieve substantial conductivity at temperatures of not higher than about 150° C., e.g., at temperatures of not higher than about 125° C., or even at temperatures of not higher than about 100° C. Any suitable method and device and combinations thereof can be used for the conversion, e.g., heating in a furnace or on a hot plate, irradiation with a light source (ultraviolet (UV) lamp, infrared (IR) or heat lamp, laser, etc.), combinations of any of these methods, to name just a few.

The forming of electronic features on polyimide coatings is highly desirable because such coatings are able to withstand these relatively high temperatures during formation of the electronic features.

In another embodiment, at least a portion of the electronic feature is formed by a process comprising the steps of: (a) depositing an electronic ink comprising a metal precursor and a liquid vehicle onto a substrate surface; and (b) reacting the metal precursor with a reducing agent under conditions effective to form the at least a portion of the electronic feature.

Non-limiting examples of other methods for processing deposited electronic inks include methods using a V, IR, laser or a conventional light source. The temperature of the deposited electronic ink can be raised using hot gas or by contact with a heated substrate. This temperature increase may result in further evaporation of vehicle and other species. A laser, such as an IR laser, can also be used for heating. An IR lamp, a hot plate or a belt furnace can also be utilized. It may also be desirable to control the cooling rate of the deposited feature.

Non-limiting examples of substrates that are particularly advantageous according to the present invention include substrates comprising one or more of FR4, fluorinated polymer, polyimide (e.g., KAPTON™), epoxy resin (including glass-filled epoxy resin), polycarbonate, polyester, polyethylene, polypropylene, polyvinyl chloride, ABS copolymer, synthetic paper, flexible fiberboard, non-woven polymeric fabric, cloth and/or other textiles. Other particularly advantageous substrates include cellulose-based materials such as wood or paper, and metallic foil and glass (e.g., thin glass). The substrate may be coated. Although the inks can be used particularly advantageously for temperature-sensitive substrates, it is to be appreciated that other substrates such as, e.g., metallic and ceramic substrates can also be used in accordance with the present invention.

Of particular interest for display applications are glass substrates and indium tin oxide (ITO) coated glass substrates. Other glass coatings that the metal features may be printed on in flat panel display applications include semiconductors such as c-Si on glass, amorphous Si on glass, poly-Si on glass, and organic conductors and semiconductors printed on glass. The glass may also be substituted with, e.g., a flexible organic transparent substrate such as PET or PEN. The metal or alloy (e.g., Ag) may also be printed on top of a black layer or coated with a black layer to improve the contrast of a display device. Other substrates of particular interest include printed circuit board substrates such as FR4, textiles including woven and non-woven textiles.

Another substrate of particular interest is natural or synthetic paper, in particular, paper that has been coated with specific layers to enhance gloss and accelerate the infiltration of ink solvent or liquid vehicle. A preferred example of a glossy coating for ink-jet paper includes alumina nanoparticles such as fumed alumina in a binder. Also, a silver ink according to the present invention that is ink-jet printed on EPSON glossy photo paper and heated for about 30 min. at about 100° C. is capable of exhibiting highly conductive Ag metal lines with a bulk conductivity in the 10 micro-Ωcm range.

According to a preferred aspect of the present invention, the substrate onto which the electronic ink is deposited may have a softening and/or decomposition temperature of not higher than about 225° C., e.g., not higher than about 200° C., not higher than about 185° C., not higher than about 150° C., or not higher than about 125° C.

The electronic features ultimately formed from the electronic inks may vary widely. For example, the electronic feature may comprise a passive feature such as a conductor, a resistor, a dielectric, an inductor, a ferromagnetic, or a capacitor. In other aspects, the electronic feature comprises an active feature such as a transistor, a sensor, a display device, or a memory device (e.g., a ROM device). The present invention is also applicable to inductor-based devices including transformers, power converters and phase shifters. Examples of such devices are illustrated in, e.g., U.S. Pat. Nos. 5,312,674; 5,604,673 and 5,828,271, the entire disclosures whereof are incorporated by reference herein.

In one aspect, the electronic features optionally are in the form of lines. In one aspect, the lines can advantageously have an average width of not greater than about 250 μm, such as not greater than about 200 μm, not greater than about 150 μm, not greater than about 100 μm, or not greater than about 50 μm.

### VI. Example

The present invention is further described with reference to the following non-limiting example.

A sample was made comprising three layers. The first layer comprised six parallel lines made from a silver-containing ink. The second layer, which substantially covered the features of the first layer, comprised an ink jettable polyimide precursor ink comprising a polyimide precursor (polyamic acid) (Chisso Corporation). The third layer comprised eight parallel lines made from a silver-containing ink that was the same ink that was used to print the lines of the first layer. The lines of the third layer were printed orthogonally relative to the lines of the first layer such that the lines of the first layer and the lines of the third layer formed a grid. All of the layers were printed using a Dimatix DMP2831 Materials printer.

More specifically, Dupont Kapton HN300 film was cleaned with denatured ethanol to remove dust and was placed on the DMP2831 printer platen. An ink comprising silver was deposited using the DMP2831 set to 1270 dpi resolution. A second deposition of this same silver ink was performed while keeping the substrate containing the first coat of silver ink on the printer platen. The second coating was performed to build of thickness of the silver layer. Upon completion of the second coating of silver ink, the substrate containing the first layer of silver (comprising 2 coats of ink) was removed from the printer and placed into a Yamato DKN600 air convection oven at 250° C. for 15 minutes. The first layer contained fiducial alignment marks to allow for improved alignment for the printing of the second and third layers.

The Kapton substrate containing the first layer of cured silver ink was re-positioned onto the printer platen. The fiducial alignment camera feature of the Dimatix DMP2831 was used to establish the printing origin for the polyimide precursor ink. The Dimatix DMP2831 printer platen was heated to 58° C. to allow for improved pinning of the ink jet polyimide precursor ink. The printing was performed using Chisso Corporation ink jet polyimide precursor ink (containing polyamic acid) with the printer set to print at 846.67 dpi resolution. The second layer comprised voids in the polyimide material that left the ends of the lines of the first layer uncovered by the polyimide material. This allowed for electrical connections to be made with the lines of the first layer.

Upon completion of the deposition of the second layer, the substrate comprising the first and second layers was placed on a hotplate and allowed to dry for 5 minutes at 80° C. Upon completion of the drying step, the sample was placed into the Yamato DKN600 oven at 230° C. for 30 minutes.

The Kapton substrate containing the first and second layers was re-positioned onto the printer platen. The fiducial alignment camera feature of the Dimatix DMP 2831 was used to establish the printing origin for the third layer. The DMP2831 printer platen was kept at a temperature of approximately 24° C. The lines of the third layer where then printed in a fashion similar to the printing of the lines of the first layer, orthogonally with respect to the lines of the first layer, and using the same ink as the ink used to print the lines of the first layer.

The substrate, now comprising the first, second and third layers was placed into a Yamato DKN600 oven at 250° C. for 30 minutes. Upon completion of the final curing step, an Omega True RMS Supermeter Multimeter was used to measure the resistance of the lines of the first layer. The end-to-end resistance measured for the lines of the first layer was approximately 7.98 ohms. The resistance measured for the lines of the third layer was approximately 2.34 ohms. When one electrode of the Multimeter was placed on a line of the first layer and the other electrode of the Multimeter was placed on a line of the third layer, a resistance was extremely high due to the existence of the polyimide layer between the first and third layers, which acted as an insulator between the lines of the first and third layers.

It is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A process for forming an electronic feature on a polyimide surface, the process comprising the steps of:
(a) providing a substrate having a first surface;
(b) depositing a polyimide precursor ink comprising a polyimide precursor on at least a portion of the first surface;
(c) converting the polyimide precursor to a polyimide on the first surface; and
(d) forming an electronic feature on the polyimide.

2. The process of claim 1, wherein the converting step forms a coating comprising the polyimide on the first surface.

3. The process of claim 2, wherein the coating has a coating surface that is more planar than the first surface.

4. The process of claim 1, wherein the polyimide precursor comprises a polyamic acid or ester.

5. The process of claim 4, wherein the polyamic acid or ester is a polyamic acid or ester of the formula: 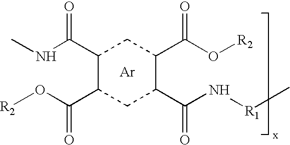
wherein 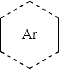
is an aromatic group;
R₁ is selected from the group consisting of an alkyl group, an alkenyl group, an alkynyl group and an aromatic group; and
R₂ is selected from the group consisting of H, an alkyl group, an alkenyl group, and an alkynyl group.

6. The process of claim 5, wherein R₁ is an alkyl group selected from the group consisting of ethyl, methyl and propyl.

7. The process of claim 5, wherein R₁ is an aromatic group selected from the group consisting of phenyl, biphenyl and naphthalenyl.

8. The process of claim 5, wherein R₂ is H.

9. The process of claim 5, wherein R₂ is an alkyl group selected from the group consisting of methyl, ethyl and propyl.

10. The process of claim 5, wherein the aromatic group is selected from the group consisting of phenyl, biphenyl and naphthalenyl.

11. The process of claim 1, wherein the polyimide precursor ink further comprises N-methylpyrrolidone, dimethyl acetamide, dimethyl formamide, ethylene glycol mono-n-butyl ether, diethylene glycol methyl ethyl ether, γ-butyrolactone, dimethyl sulfoxide, diethyleneglycol butylether, or ethanolamine.

12. The process of claim 1, wherein the converting step comprises heating the deposited polyimide precursor ink.

13. The process of claim 12, wherein the heating comprises heating the deposited polyimide precursor ink to a maximum temperature of from about 150° C. to about 350° C.

14. The process of claim 1, wherein the depositing step comprises depositing the polyimide precursor ink onto the first surface by a direct write printing process.

15. The process of claim 1, wherein the depositing step comprises depositing the polyimide precursor ink onto the first surface by an ink jet printing process.

16. The process of claim 1, wherein the polyimide has the formula: 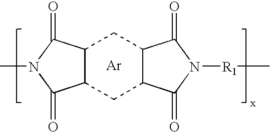
wherein 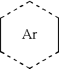
is an aromatic group; and
wherein R₁ is selected from the group consisting of an alkyl group, an alkenyl group, an alkynyl group and an aromatic group.

17. The process of claim 16, wherein R₁ is an alkyl group selected from the group consisting of ethyl, methyl and propyl.

18. The process of claim 16, wherein R₁ is an aromatic group selected from the group consisting of phenyl, biphenyl and naphthalenyl.

19. The process of claim 16, wherein the aromatic group is selected from the group consisting of phenyl, biphenyl and naphthalenyl.

20. The process of claim 1, wherein the polyimide precursor ink has a viscosity of less than about 50 centipoise.

21. The process of claim 1, wherein the polyimide precursor ink has a surface tension of from about 10 dynes/cm to about 50 dynes/cm.

22. The process of claim 1, wherein the forming step comprises:
applying a second ink onto at least a portion of the polyimide; and
treating the second ink under conditions effective to form at least a portion of the electronic feature.

23. The process of claim 22, wherein the treating of the second ink comprises heating the deposited second ink to a maximum temperature of from about 150° C. to about 400° C.

24. The process of claim 1, wherein the substrate is selected from the group consisting of a fluorinated polymer, polyimide, epoxy resin, polycarbonate, polyester, polyethylene, polypropylene, polyvinyl chloride, ABS copolymer, wood, paper, metallic foil, glass, flexible fiberboard, non-woven polymeric fabric, and cloth.

25. The process of claim 1, wherein the substrate comprises a polyimide film.

26. The process of claim 1, wherein the substrate comprises glass.

27. The process of claim 1, wherein the electronic feature is selected from the group consisting of a conductor, a resistor, a capacitor, an inductor, a dielectric and a semiconductor.

28. The process of claim 1, wherein the polyimide has a molecular weight ranging from about 10,000 to about 10,000,000 amu.

29. A process for forming a multi-layer feature, the process comprising the steps of:
(a) providing at least a portion of a first electronic feature on a substrate, the first electronic feature having a feature surface;
(b) depositing a polyimide precursor ink comprising a polyimide precursor on at least a portion of the feature surface;
(c) converting the polyimide precursor to a polyimide on the at least a portion of the feature surface.

30. The process of claim 29, wherein the process further comprises the step of:
(d) depositing a second ink on at least a portion of the polyimide.

31. The process of claim 30, wherein the process further comprises the step of:
(e) treating the second ink under conditions effective to form at least a portion of a second electronic feature.

32. The process of claim 31, wherein first electronic feature comprises a first conductive trace and the second electronic feature comprises a second conductive trace, and wherein the first and second conductive traces are insulated from one another by the polyimide.

33. The process of claim 31, wherein the second ink comprising a metallic composition.

34. The process of claim 33, wherein the metallic composition comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead.

35. The process of claim 33, wherein the metallic composition comprises an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead.

36. The process of claim 31, wherein the second ink comprises a metal precursor to a metal, the metal being selected from the group consisting of silver, gold, copper, nickel, cobalt, palladium, platinum, indium, tin, zinc, titanium, chromium, tantalum, tungsten, iron, rhodium, iridium, ruthenium, osmium and lead.

37. The process of claim 29, wherein the polyimide precursor ink is selectively deposited on a portion of the feature surface to form a polyimide layer comprising the polyimide, the polyimide layer having a void therein, the process further comprising the steps of:
(d) depositing a via ink in at least a portion of the void; and
(e) treating the deposited via ink under conditions effective to form a via.

38. The process of claim 37, wherein the process further comprises the step of:
(f) depositing a second ink on at least a portion of the polyimide layer.

39. The process of claim 38, wherein the process further comprises the step of:
(g) treating the second ink under conditions effective to form at least a portion of a second electronic feature, the second electronic feature being electrically coupled to the first electronic feature by the via.

40. The process of claim 39, wherein steps (e) and (g) occur simultaneously.

41. The process of claim 39, wherein the treating of the second ink comprises heating the deposited second ink to a maximum temperature of from about 150° C. to about 400° C.

42. The process of claim 29, wherein the converting step forms a coating comprising the polyimide on the feature surface.

43. The process of claim 29, wherein the polyimide precursor comprises a polyamic acid or ester.

44. The process of claim 43, wherein the polyamic acid or ester is a polyamic acid or ester of the formula: 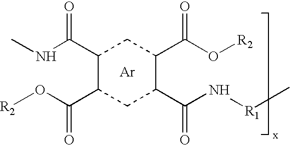
wherein 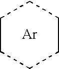
is an aromatic group;
R₁ is selected from the group consisting of an alkyl group, an alkenyl group, an alkynyl group and an aromatic group; and
R₂ is selected from the group consisting of H, an alkyl group, an alkenyl group, and an alkynyl group.

45. The process of claim 44, wherein R₁ is an alkyl group selected from the group consisting of ethyl, methyl and propyl.

46. The process of claim 44, wherein R₁ is an aromatic group is selected from the group consisting of phenyl, biphenyl and naphtalenyl.

47. The process of claim 44, wherein R₂ is H.

48. The process of claim 44, wherein R₂ is an alkyl group selected from the group consisting of methyl, ethyl and propyl.

49. The process of claim 44, wherein the aromatic group is selected from the group consisting of phenyl, biphenyl and naphthalenyl.

50. The process of claim 29, wherein the polyimide precursor ink further comprises N-methylpyrrolidone, dimethyl acetamide, dimethyl formamide, ethylene glycol mono-n-butyl ether, diethylene glycol methyl ethyl ether, γ-butyrolactone, dimethyl sulfoxide, diethyleneglycol butylether, or ethanolamine.

51. The process of claim 29, wherein the converting step comprises heating the deposited polyimide precursor ink.

52. The process of claim 51, wherein the heating comprises heating the deposited polyimide precursor ink to a maximum temperature of from about 150° C. to about 350° C.

53. The process of claim 29, wherein the depositing step comprises depositing the polyimide precursor ink onto the feature surface by a direct write printing process.

54. The process of claim 29, wherein the depositing step comprises depositing the polyimide precursor ink onto the feature surface by an ink jet printing process.

55. The process of claim 29, wherein the polyimide has the formula: 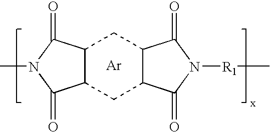
wherein 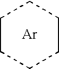
is an aromatic group; and
wherein R₁ is selected from the group consisting of an alkyl group, an alkenyl group, an alkynyl group and an aromatic group.

56. The process of claim 55, wherein R₁ is an alkyl group selected from the group consisting of ethyl, methyl and propyl.

57. The process of claim 55, wherein R₁ is an aromatic group selected from the group consisting of phenyl, biphenyl and naphtalenyl.

58. The process of claim 55, wherein the aromatic group is selected from the group consisting of phenyl, biphenyl and naphtalenyl.

59. The process of claim 29, wherein the polyimide precursor ink has a viscosity of less than about 50 centipoise.

60. The process of claim 29, wherein the polyimide precursor ink has a surface tension of from about 10 dynes/cm to about 50 dynes/cm.

61. The process of claim 29, wherein the substrate is selected from the group consisting of a fluorinated polymer, polyimide, epoxy resin, polycarbonate, polyester, polyethylene, polypropylene, polyvinyl chloride, ABS copolymer, wood, paper, metallic foil, glass, flexible fiberboard, non-woven polymeric fabric, and cloth.

62. The process of claim 29, wherein the substrate comprises a polyimide film.

63. The process of claim 29, wherein the substrate comprises glass.

64. The process of claim 29, wherein the polyimide has a molecular weight ranging from about 10,000 to about 10,000,000 amu.
